(19) United States
(12) Patent Application Publication
(10) Pub. No.: US 2012/0064311 A1
(43) Pub. Date: Mar. 15, 2012

(54) CAMOUFLAGE DEVICE

(75) Inventor: Asaf Picciotto, Tel Aviv (IL)

(73) Assignee: POLARIS SOLUTIONS LTD, ROSH HA'AYIN (IL)

(21) Appl. No.: 13/321,552

(22) PCT Filed: May 23, 2010
(86) PCT No.: PCT/IL10/00406

§ 371 Date: Nov. 21, 2011

Related U.S. Application Data
(60) Provisional application No. 61/180,141, filed on May 21, 2009.

(51) Int. Cl. B32B 3/10; B29C 51/14; B05D 5/00; B31B 1/62

(52) U.S. Cl. 428/195.1; 156/60; 156/224; 427/267

(57) ABSTRACT

A camouflage sheet including a substrate of shapeable material capable of retaining its shape, for forming a three dimensional structure to provide a heat signature not characteristic of the object, the shapeable material being re-shapeable on site, and a visible pattern on the shapeable material mimicking the surroundings of the object to be protected, for protecting an object from detection in both the visible and the IR spectrum.

### FIELD OF THE INVENTION

The present invention relates to a camouflage device, in general and, in particular, to a camouflage sheet.

### BACKGROUND OF THE INVENTION

Camouflage is an essential part of modern military tactics aiming to maintain the surprise factor in the battlefield. Generally, the intent of camouflage is to disrupt an outline of an object by merging it with the surroundings, thus, making it harder for an outside observer to spot and hit the object. As used herein, the term “object” refers to one or more objects and/or one or more persons.

Traditionally, camouflage products include a surface, such as a uniform or a sheet having a pattern attempting to mimic a certain natural appearance, such as leaves, bark, trees, shrubs, grass, etc. These camouflage sheets can be used to form uniforms for military troops. Alternatively, these camouflage sheets can be used for covering a small team of soldiers or equipment, such as tanks, cannons, etc.

However, with the evolvement of IR cameras and night vision instruments, a person or a heat emitting object can be detected, even when hiding behind a camouflage sheet having a visual pattern.

U.S. Pat. No. 6,338,292 to Reynolds et al. describes a camouflaging device in both the visual spectrum and the infrared spectrum by emulating the infrared radiation of an object's background and the visible radiation of an object's background. The external surface of the object or a protective shield including choleric liquid crystals is then heated or cooled using thermoelectric modules that convert electrical energy into a temperature gradient.

However, this camouflage device requires a power source for activating the thermoelectric modules. Furthermore, although this camouflaging device includes a surface of liquid crystals forming a pattern mimicking specific surroundings, the shape of the device is not one which blends in the surroundings, and, thus, can be detected when observed from a short distance.

Accordingly, there is a long felt need for a camouflage device for concealing in both the visible and IR spectrum without the need for a power source, and it would be very desirable to have such a camouflage device which can also be retainably shaped into any desired three-dimensional structure.

### SUMMARY OF THE INVENTION

The present invention relates to a flexible, portable camouflage device for protecting an object or person from detection in both the visible and the IR spectrum.

There is provided according to the present invention a camouflage sheet including a substrate of shapeable material capable of retaining its shape, for protecting an object from detection in both the visible and the IR spectrum. The shapeable material is re-shapeable for forming a three dimensional structure sized to conceal the object and provide an air buffer for thermal insulation of the object, so as to provide a heat signature not characteristic of the object, and a visible pattern on the shapeable material mimicking the surroundings of the object to be protected.

According to a preferred embodiment, the camouflage sheet further includes at least one coating layer affixed to the shapeable material. A pattern mimicking the surroundings of the object to be protected, is part of the coating layer .

According to some embodiments of the invention, the coating layer is a fabric layer.
There is also provided, according to the invention, a method for forming a camouflage sheet, the method including providing a substrate of shapeable material capable of retaining its shape, for providing a heat signature not characteristic of the object, the shapeable material being re-shapeable,

and providing a visible pattern mimicking the surroundings of the object to be protected on the shapeable material.

### BRIEF DESCRIPTION OF THE DRAWINGS

The present invention will be further understood and appreciated from the following detailed description taken in conjunction with the drawings in which:

FIG. 1 is an exploded view of a camouflage sheet constructed and operative in accordance with one embodiment of the present invention;

FIG. 2 is a perspective view of the camouflage sheet of FIG. 1;

FIG. 3 is a perspective view illustration of the camouflage sheet of FIG. 1, constructed and operative in accordance with one embodiment of the present invention, having a band;

FIG. 4 is a perspective view illustration of a camouflage sheet in accordance with another embodiment of the present invention, having a vegetation pattern;

FIG. 5 is a perspective view illustration of a camouflage sheet according to another embodiment of the invention, having a sandy pattern;

FIG. 6 is a perspective view illustration of the camouflage sheet of FIG. 1, shaped as a boulder;

FIG. 7 is a perspective view illustration of a camouflage sheet constructed and operative in accordance with another embodiment of the present invention; and,

FIG. 8 is an exploded view of the camouflage sheet of FIG. 7.

### DETAILED DESCRIPTION OF THE INVENTION

The present invention relates to a shapeable camouflage sheet for concealing a person or an object from detection in the visible light spectrum and the IR light spectrum. As used herein, IR radiation refers to any radiation in the entire IR spectrum, including near IR, far IR and thermal radiation. The camouflage sheet includes a shapeable substrate, such as a metallic substrate, whose shape can be changed in the field. The shapeable substrate has a surface with a visible design or pattern, or includes a coating layer or attached layer having a visible pattern or design that mimics a portion of the surroundings of the object or person to be protected. The coating or layer is affixed at least on one side of the substrate. The shapeable substrate is formed of a material, such as metal, which can be easily shaped into, and retain temporarily, any desired three-dimensional shape, such as a boulder, a wall segment, a mound, etc., and that can be re-shaped, as required, on site. The visible pattern is, preferably, one which mimics a specific surrounding, such as a pattern of rocks and boulders, a pattern of natural vegetation, or a pattern of bricks mimicking an external wall of a building.

Unlike conventional camouflage sheets, which are usually draped over an object to be protected, the shapeable substrate can be retainably shaped into any desired three-dimensional structure sized for concealing one or more persons or objects. When the substrate is shaped into a three-dimensional structure, the pattern on the substrate is visible at least from the outside of the three dimensional structure. The three-dimensional structure is sized to provide an air buffer for thermal insulation enclose a sufficient volume of air within it to provide isolation between the substrate and a person or an object which it conceals. The air inside the structure between the substrate and the object or person mitigates the heat radiated by the person or the object, thus, the heat signature (emitted IR radiation) of the substrate is not one which is characteristic of IR radiation of a human or a heat emitting object, such as an engine. A non-distinctive heat signature is created by the sheet because the heat radiated from the object hidden behind the three dimensional structure is unevenly absorbed by the shaped substrate. This is due to the fact that the object hidden inside the structure is closer to some portions of the structure and is further away from others. This way, more air is present between the object and the substrate portions which are further away than between the substrate portions which are closer. Since the air serves as insulation between the object and the camouflage sheet, the portions of the sheet which are further from the object are cooler and, thus, emit less IR radiation. This results in a heat signature radiating from the camouflage sheet which is not characteristic of a heat signature of a heat emitting object, such as a human being, or a motor.

Preferably, the pattern on the camouflage sheet, which is visible from outside of the three dimensional structure, is selected to match and blend in with the surroundings. Thus, the camouflage sheet according to the present invention makes it difficult to sight an object hidden behind it both when observed in the visible and IR light spectrum.

According to one embodiment of the invention, the coating layer is a fabric layer which is affixed to the substrate, and a visible pattern is part of the coating layer. The fabric layer protects the substrate from scratches and can be replaced when the pattern is discolored or when a different pattern is required.

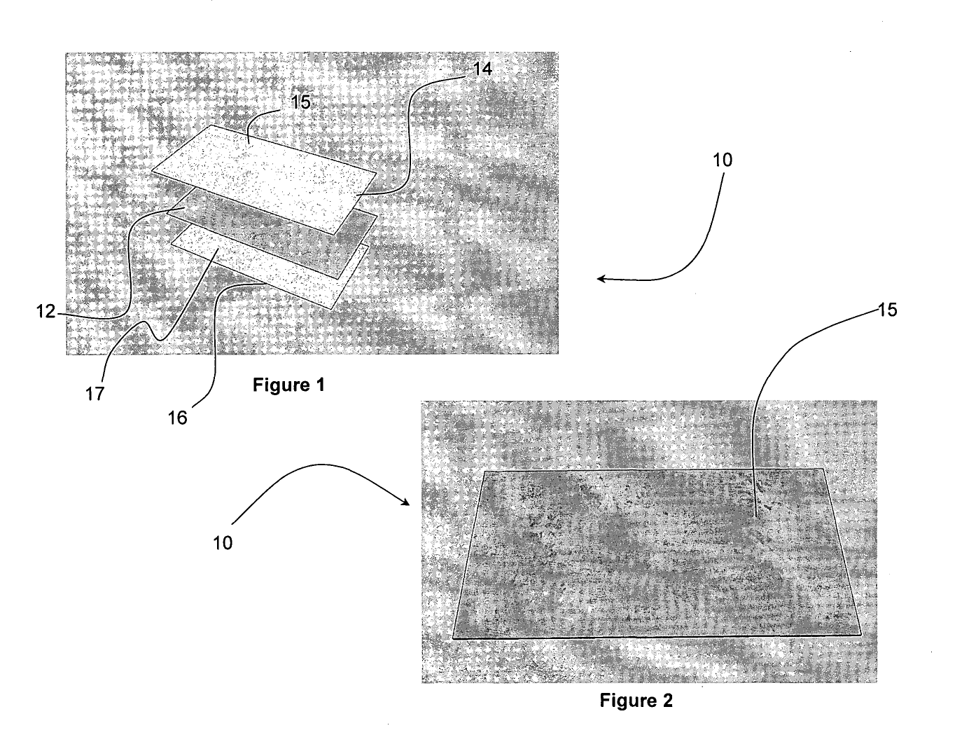

FIGS. 1 and 2 are an exploded illustration, and a perspective view illustration, respectively, of a camouflage sheet 10 constructed and operative according to one embodiment of the present invention. Camouflage sheet 10 includes a retainably shapeable substrate 12, a first fabric layer 14 and, preferably, a second fabric layer 16. Substrate 12 can be retainably folded inwardly or outwardly in any desired angle, and it can be wrinkled or formed with a selected texture, so as to provide its surface with a protruding pattern. It will be appreciated that the shape and size of substrate 12 may be determined in accordance with the space which is required for concealing a desired number of men, vehicles, material, etc. First fabric layer 14 embodies a pattern 15 mimicking certain surroundings, here illustrated as rocky surroundings. For example, pattern 15 may be printed, painted, dyed or woven into fabric layer 14, and may include one or more colors.

Fabric layer 14 is affixed to a first side of substrate 12. Preferably, second fabric layer 16 is provided, and is affixed to the second side of substrate 12. Second fabric layer 16 provides camouflage sheet 10 with additional strength, and protects substrate 12 from scratches on the second side of the substrate. Second fabric layer 16 may also include a pattern 17, which may be similar to pattern 15 on first fabric layer 14. Alternatively, pattern 17 on second fabric layer 16 may be different than pattern 15 of first fabric layer 14. For example, pattern 15 may mimic a rocky surface, while pattern 17 may mimic vegetation. This way, camouflage sheet 10 can be utilized for camouflaging in more than one environment, as described herein below. It will be appreciated that first and second fabric layers 14 and 16, respectively, may include camouflaging elements other than, or in addition to, patterns, for example, fake leaves attached thereon, mimicking the appearance of a bush or a tree.

Preferably, affixing fabric layers 14 and 16 to substrate 12 is carried out by applying a layer of adhesive material on both sides of substrate 12, and attaching first fabric layer 14 on a first side of substrate 12, and second fabric layer 16 on a second side of substrate 12. Gluing fabric layers 14 and 16 to substrate 12 provides camouflage sheet 10 with additional strength, and precludes separation of the different layers of camouflage sheet 10. Alternatively, heat welding or any other affixing method may be utilized.

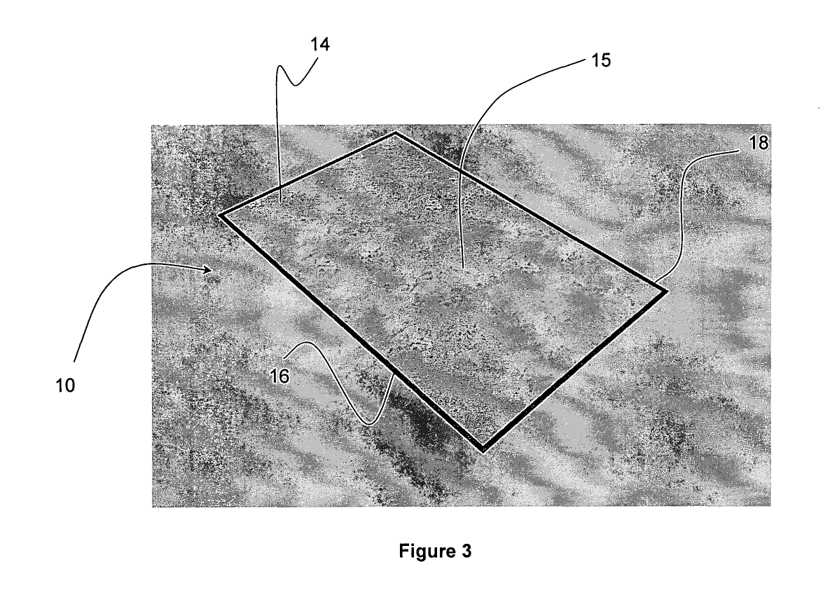

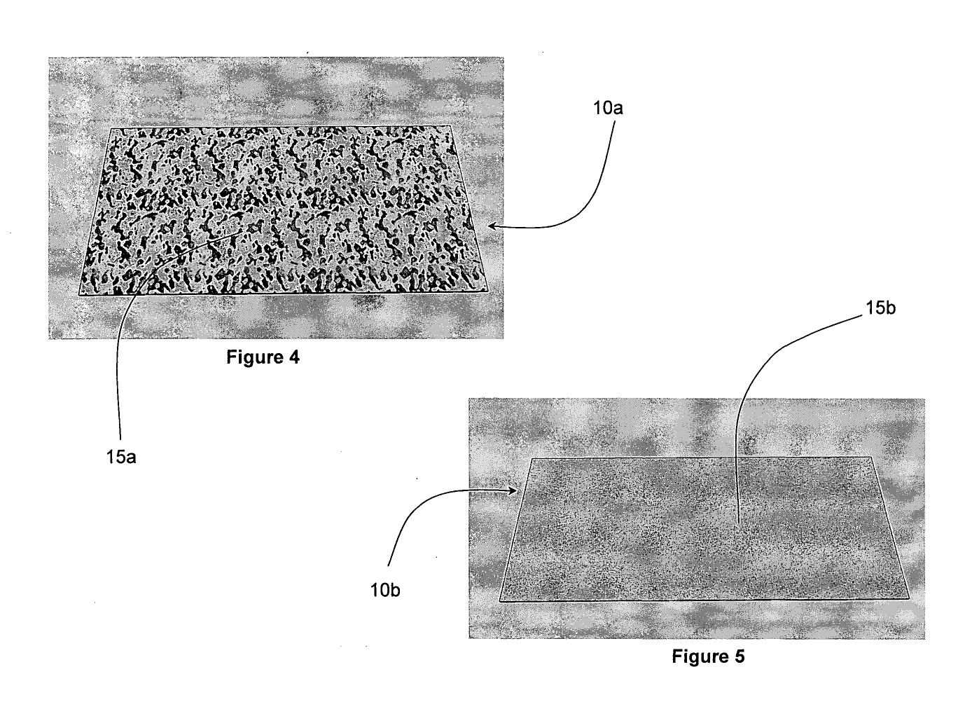

When the pattern on first and second fabric layers 14 and 16, respectively, is painted on the fabric, a base color is preferably applied onto first and second fabric layers 14, 16 prior to painting the pattern. The base color stabilizes the paints forming the pattern, so as to sustain the coloration of the pattern. The pattern can be selected to mimic any desired element in the surroundings of the object to be protected. For example, the pattern painted on first and second fabric layers 14, 16 can be selected to imitate a rocky surface, as seen in the FIG. 3. Alternatively, the pattern may be pattern may be selected to imitate vegetation, such as pattern 15a on camouflage sheet 10a illustrated in the FIG. 4, or to imitate a sandy surface, such as pattern 15b on camouflage sheet 10b seen in FIG. 5.

As shown in FIG. 3, preferably, camouflage sheet 10 further includes a band 18 affixed about the perimeter of substrate 12 and fabric layers 14 and 16. Band 18 protects the edges of fabric layers 14 and 16, and of sheet 10, as a whole, and precludes unraveling of the fabric.

Camouflage sheet 10 can be retainably shaped to encompass a desired number of persons, vehicles, objects etc. or to provide a camouflaged barrier. For example, a soldier in a battlefield may shape camouflage sheet 10 to imitate a boulder and hide behind it. It will be appreciated that in order to conceal the soldier, the camouflage sheet need not imitate a complete boulder, and a wall of a boulder facing the enemy may suffice. Preferably, camouflage sheet 10 is malleable and can be creased or wrinkled or otherwise shaped to adapt the outside appearance of a rough surface. It is a particular feature of the present invention that substrate 10 is formed of a material which is flexible enough to be shaped, and re-shaped at a later time, in the field by hand or aided by hand tools, yet it possess sufficient mechanical strength which permits it to retain the given shape.

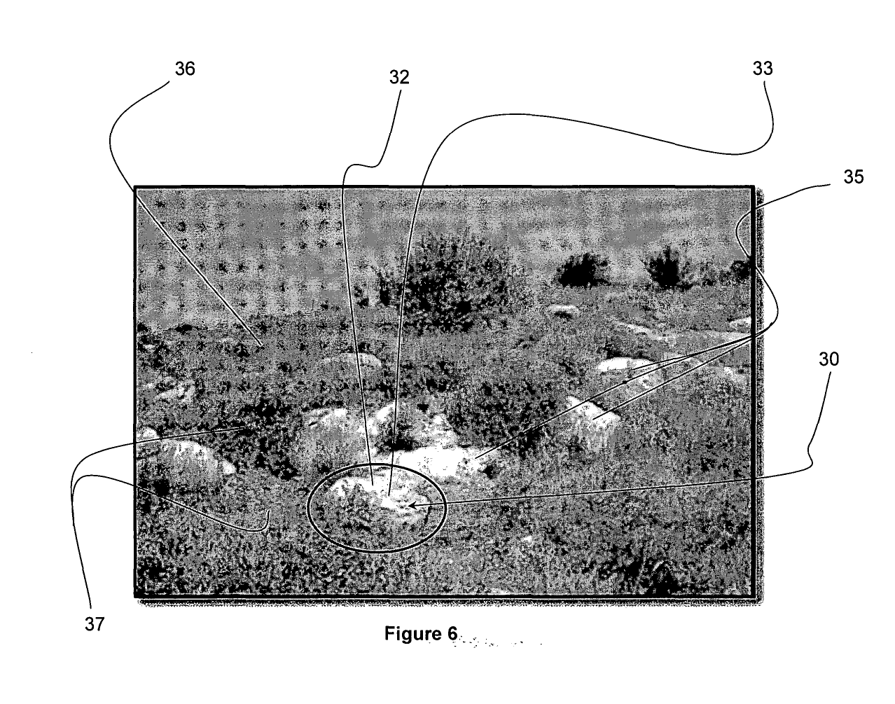

FIG. 6 is a perspective view of a camouflage sheet 30, constructed and operative in accordance with one embodiment of the invention, shaped as the contour of a boulder. Camouflage sheet 30 includes a retainably shapeable substrate (not shown) and a fabric layer 32 affixed to the substrate and having a rocky pattern 33. In order to blend in the surroundings, camouflage sheet 30 is shaped as a boulder with a rough surface, thereby adopting the outside appearance of a rocky surface. Camouflage sheet 30 is disposed between real boulders 35 and bushes 37 in a field 36, so as to allow hiding an object behind or beneath it.

When the boulder-like shaped camouflage sheet 30 is observed with an IR night vision instrument, the heat signature is not one which is typical of an heat emitting object or a human being, since different portions of the camouflage sheet 30 radiate at different temperatures, depending on their relative distance from an object hidden behind or inside shaped camouflage sheet 30.

It will be appreciated that camouflage sheet 30 may be adapted to conceal one or more persons or it may be adapted to conceal an object of any size and shape.

When the camouflage sheet includes two fabric layers, for example, a first fabric layer having a rocky pattern, and a second fabric layer having a vegetation pattern, the camouflage sheet can be used in both rocky surroundings, or vegetation surroundings. In rocky surroundings, the camouflage sheet can be given the shape of a rock or a boulder and be disposed with the first fabric layer, having the rocky pattern, facing the outer side, and the second fabric layer, having the vegetation pattern, facing the inner side of the camouflage sheet 30. When deployed in vegetation, the camouflage sheet can be given the shape of a bush and be disposed with the second fabric layer, having the vegetation pattern, facing out side, and the first fabric layer, having the rocky pattern facing, the inner side of the camouflage sheet 30.

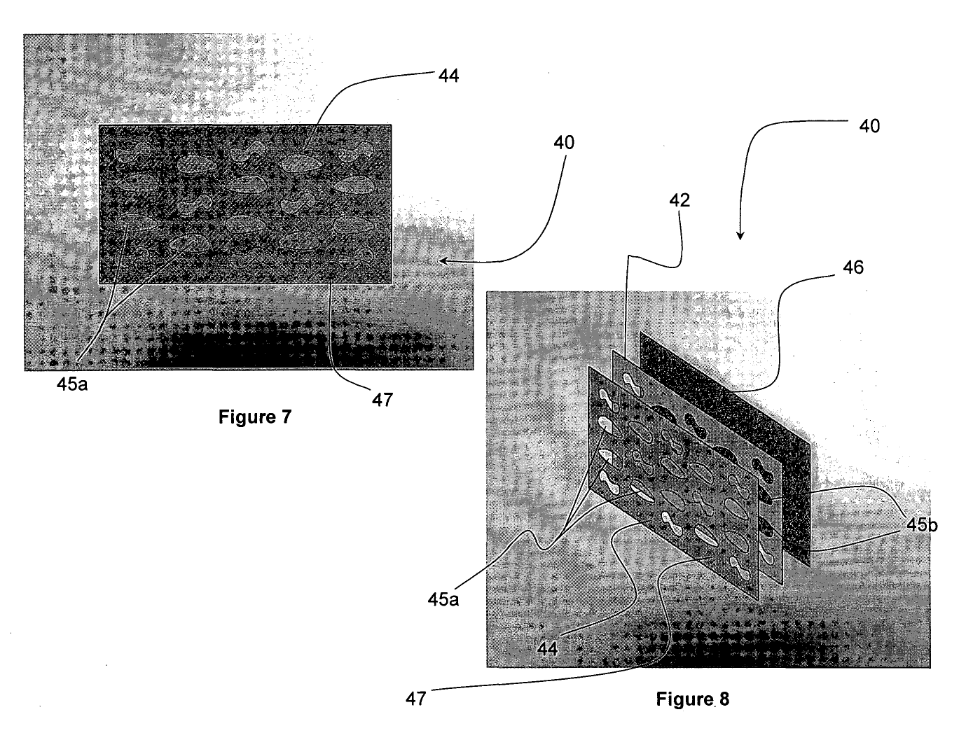

FIGS. 7 and 8 are a front view and an exploded illustration, respectively, of a camouflage sheet 40, constructed and operative according to another embodiment of the present invention. Camouflage sheet 40 includes a retainably shapeable substrate 42, a first fabric layer 44, and a second fabric layer 46. Substrate 42, first fabric layer 44, and second fabric layer 46 are formed of substantially the same materials as retainably shapeable substrate 12, first fabric layer 14, and second fabric layer 16, respectfully, of FIG. 1, and can be affixed together, shaped and creased as desired. According to this embodiment, substrate 42 further includes a plurality of apertures 45a, and first fabric layer 44 also includes a plurality of apertures 45b, here shown in registration with apertures 45a. Apertures 45a have substantially the same shapes as apertures 45b and, when substrate 42 is affixed to first fabric layer 44, apertures 45a are substantially aligned with apertures 45b. When a person or a heat emitting object are concealed under camouflage sheet 40, the heat radiating through apertures 45a and 45b is greater than the heat radiating from other portions of camouflage sheet 40. Thus, the heat signature of camouflage sheet 40 is not a typical heat signature of a person or a heat emitting object. Since, according to this embodiment, since the pattern of second fabric layer 46 can be viewed through apertures 45a and 45b from the outer side of camouflage sheet 40, it may be preferred that the pattern 47 on first fabric layer 44 be substantially the same as the pattern on second fabric layer 46. Thus, it is difficult to detect the camouflage sheet in the visible light spectrum due to pattern 47, which is visible from the outer side of camouflage sheet 40, and it is difficult to detect a person or heat emitting objects in the IR light spectrum hiding under or behind the camouflage sheet due to the unidentifiable or non-distinguishable heat signature.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A camouflage sheet for an object, the camouflage sheet comprising:
a shapeable substrate capable of retaining its shape, said substrate being re-shapeable, for forming a three dimensional structure sized to conceal the object and provide an air buffer for thermal insulation of the object, so as to provide a heat signature not characteristic of the object; and
a visible pattern on said shapeable material mimicking surroundings of the object to be concealed.

2. The camouflage sheet according to claim 1, further comprising:
at least one coating layer affixed to said shapeable material, wherein said visible pattern is part of said coating layer.

3. The camouflage sheet according to claim 2, wherein said coating layer comprises a fabric layer.

4. The camouflage sheet according to claim 2, wherein said coating layer comprises a paint layer.

5. The camouflage sheet according to claim 1, comprising two coating layers, wherein one of said coating layers is affixed to each surface of said shapeable material, each said coating layer including a visible pattern.

6. The camouflage sheet according to claim 2, further comprising a second coating layer, wherein said substrate and said coating layer include apertures in registration with one another.

7. The camouflage sheet according to claim 1, further comprising a protective band around a perimeter of said substrate.

8. A method for forming a camouflage sheet, the method comprising:
providing a substrate of shapeable material capable of retaining its shape, to provide a heat signature not characteristic of the object, said shapeable material being re-shapeable; and
providing a visible pattern mimicking the surroundings of the object to be protected on said shapeable material.

9. The method according to claim 8, further comprising affixing at least one coating layer to said shapeable material.

10. The method according to claim 8, wherein said step of providing a pattern includes displaying said visible pattern on said shapeable material.

11. The method according to claim 8, wherein said wherein said step of providing a pattern includes displaying said visible pattern on said coating layer.

12. The method according to claim 9, wherein said coating layer comprises a fabric layer.

13. The method according to claim 8, comprising affixing two coating layers to said shapeable material.

14. The method according to claim 8, further comprising forming a three dimensional structure from said sheet, said structure being sized to conceal the object and provide an air buffer for thermal insulation of the object, so as to provide a heat signature not characteristic of the object.

15. The camouflage sheet according to claim 5, further comprising a protective band around a perimeter of said substrate.

16. The camouflage sheet according to claim 6, further comprising a protective band around a perimeter of said substrate.

17. The method according to claim 9, further comprising forming a three dimensional structure from said sheet, said structure being sized to conceal the object and provide an air buffer for thermal insulation of the object, so as to provide a heat signature not characteristic of the object.

18. The method according to claim 13, further comprising forming a three dimensional structure from said sheet, said structure being sized to conceal the object and provide an air buffer for thermal insulation of the object, so as to provide a heat signature not characteristic of the object.
